(19) United States
(12) Patent Application Publication
(10) Pub. No.: US 2026/0106346 A1
(43) Pub. Date: Apr. 16, 2026

(54) SYSTEMS AND METHODS FOR ELECTRICAL SIGNAL CONDUCTION TO HERMETICALLY SEALED ELECTROCHEMICAL CELLS

(71) Applicant: 24M Technologies, Inc., Cambridge, MA (US)

(72) Inventors: Terry Lee LAMB, Sharpsville, IN (US); Steven Alan ALFORD, Alexandria, IN (US); Evan Matthew JAMIESON, Indianapolis, IN (US); Mark CHILDS, Anderson, IN (US); Mark YOUNG, Lapel, IN (US); Chad Alan HARTZOG, Columbus, IN (US)

(21) Appl. No.: 19/334,234

(22) Filed: Sep. 19, 2025

Related U.S. Application Data
(60) Provisional application No. 63/705,876, filed on Oct. 10, 2024.

(51) Int. Cl. H01M 50/569; H01M 10/04; H01M 10/42; H01M 50/134; H01M 50/141; H01M 50/184; H01M 50/186; H01M 50/466; H01M 50/474

(52) U.S. Cl. CPC H01M 50/569; H01M 10/049; H01M 10/425; H01M 50/134; H01M 50/141; H01M 50/184; H01M 50/186; H01M 50/466; H01M 50/474; H01M 2010/4271

(57) ABSTRACT

Embodiments described herein relate to hermetically sealed electrochemical cells. In some aspects, an electrochemical cell assembly can include an anode disposed on an anode current collector, a cathode disposed on a cathode current collector, and a separator disposed between the anode and the cathode. A hermetic enclosure contains the anode, the anode current collector, the cathode, the cathode current collector, and the separator. An electronic circuit is electrically and/or communicatively coupled to at least one of the anode or the cathode, such that a first portion of the electronic circuit is inside the hermetic enclosure and a second portion of the electronic circuit is outside of the hermetic enclosure. The electronic circuit can includes a printed flex circuit polyimide, and/or an aluminized polymer pouch.

### CROSS-REFERENCE TO RELATED APPLICATIONS

The present application claims priority to and the benefit of U.S. Provisional Application No. 63/705,876, filed Oct. 10, 2024, and entitled “Systems and Methods for Electrical Signal Conduction to Hermetically Sealed Electrochemical Cells,” the entire disclosure of which is hereby incorporated by reference herein.

### TECHNICAL FIELD

Embodiments described herein relate to transmission of electrical signals and/or energy to hermetically sealed electrochemical cells.

### BACKGROUND

Hermetic sealing of electrochemical cells can be important for keeping moisture and contaminants out of the cell. Hermetic seals can prevent degradation of the electrochemical cell and prolong the usable life of the electrochemical cell. Transmission of electrical signals or other information through a hermetic seal can be difficult. Maintaining hermeticity in the sealed region is a delicate practice, and any overpenetration of the seal can compromise the quality and effectiveness of the seal. By controlling inbound and outbound electrical paths through the hermetic seal, the integrity of the seal and the quality of the electrochemical cell can be maintained.

### SUMMARY

Embodiments described herein relate to hermetically sealed electrochemical cells. In some aspects, an electrochemical cell assembly can include an anode disposed on an anode current collector, a cathode disposed on a cathode current collector, and a separator disposed between the anode and the cathode. A hermetic enclosure contains the anode, the anode current collector, the cathode, the cathode current collector, and the separator. An electronic circuit is electrically and/or communicatively coupled to at least one of the anode or the cathode, such that a first portion of the electronic circuit is inside the hermetic enclosure and a second portion of the electronic circuit is outside of the hermetic enclosure. In some embodiments, the electronic circuit includes a printed flex circuit. In some embodiments, the printed flex circuit can include polyimide. In some embodiments, the hermetic enclosure can include an aluminized polymer pouch. In some embodiments, a section of polypropylene tape can be disposed at an interface between the electronic circuit and the hermetic enclosure to provide hermeticity. In some embodiments, the hermetic enclosure can have a humidity penetration rate of no more than about 1×10⁻8 cc/s.

In some embodiments, an electrochemical device includes: an electrochemical cell; a hermetic enclosure configured to house the electrochemical cell; and a printed flex circuit communicatively coupled to the electrochemical cell, the printed flex circuit positioned such that a first portion of the printed flex circuit is inside the hermetic enclosure and a second portion of the printed flex circuit is outside the hermetic enclosure.

In some embodiments, a method comprising: disposing an anode on an anode current collector; disposing a cathode on a cathode current collector; disposing a separator between the anode and the cathode to form an electrochemical cell; communicatively coupling an electronic circuit to at least one of the anode or the cathode; and hermetically sealing the electrochemical cell inside a sealed region such that a first portion of the electronic circuit is inside the sealed region and a second portion of the electronic circuit is outside the sealed region.

### BRIEF DESCRIPTION OF THE DRAWINGS

FIG. 1 is a block diagram of an electrochemical apparatus including a hermetic seal, according to an embodiment.

FIG. 2 is an illustration of an electrochemical apparatus including a hermetic seal, according to an embodiment.

FIG. 3 is an illustration of an interface between an electronic circuit and an electrochemical cell, according to an embodiment.

FIG. 4 is an illustration of an interface between an electronic circuit and a hermetic enclosure, according to an embodiment.

FIG. 5 is an illustration of an electrochemical apparatus including a hermetic seal, according to an embodiment.

FIG. 6 is a flow diagram of a method of forming an electrochemical apparatus including a hermetic seal, according to an embodiment.

### DETAILED DESCRIPTION

Embodiments described herein relate to hermetic seals in electrochemical cells and apparatus including electrochemical cells. Hermetic enclosures described herein can include a thin heat seal to seal out moisture and contaminants, prolonging the life of the electrochemical cell. Heat seals in electrochemical cells are often very fragile, and any wire, cord, or other component that penetrates the heat seal is sized such that it minimizes the disturbance to the hermetic seal. Wires or cords that penetrate hermetic seals are often limited to be no thicker than 1.5 mm. Particularly, wires with round cross sections often are not sealable in hermetic enclosures, due to the non-gradual change in opening size created by the round shape of the wires. The inclusion of an electronic circuit such as a circuit board or a printed flex circuit to penetrate the hermetic seal provides a low-cost option for maintaining hermeticity. Such components can also be mass-produced with high repeatability and quality.

Other hermetic seal components that conduct signals and power from inside the electrochemical cell are expensive and often require a metal enclosure. This increases the cost of the electrochemical cell system, as well as its weight and specific energy/specific power. In some embodiments, electrical signals and/or power can be transferred via printed flex circuits described herein. In some embodiments, electrical signals and/or power can be transferred remotely (i.e., via a transmitter/receiver). In some embodiments, pouches and/or enclosures described herein can have any of the properties of those described in U.S. Pat. No. 11,024,903 (“the '903 patent”), filed Nov. 27, 2018 and titled “Single Pouch Battery Cells and Methods of Manufacture,” the disclosure of which is hereby incorporated by reference in its entirety.

Electrodes described herein can include conventional electrodes and/or semi-solid electrodes. Semi-solid electrodes described herein can be made: (i) thicker (e.g., greater than 100 μm-up to 2,000 μm or even greater) due to the reduced tortuosity and higher electronic conductivity of the semi-solid electrode, (ii) with higher loadings of active materials, and (iii) with a simplified manufacturing process utilizing less equipment. These relatively thick semi-solid electrodes decrease the volume, mass and cost contributions of inactive components with respect to active components, thereby enhancing the commercial appeal of batteries made with the semi-solid electrodes. In some embodiments, the semi-solid electrodes described herein are binderless and/or do not use binders that are used in conventional battery manufacturing. Instead, the volume of the electrode normally occupied by binders in conventional electrodes, is now occupied by: 1) electrolyte, which has the effect of decreasing tortuosity and increasing the total salt available for ion diffusion, thereby countering the salt depletion effects typical of thick conventional electrodes when used at high rate, 2) active material, which has the effect of increasing the charge capacity of the battery, or 3) conductive additive, which has the effect of increasing the electronic conductivity of the electrode, thereby countering the high internal impedance of thick conventional electrodes. The reduced tortuosity and a higher electronic conductivity of the semi-solid electrodes described herein, results in superior rate capability and charge capacity of electrochemical cells formed from the semi-solid electrodes. Since the semi-solid electrodes described herein, can be made substantially thicker than conventional electrodes, the ratio of active materials (i.e., the semi-solid cathode and/or anode) to inactive materials (i.e., the current collector and separator) can be much higher in a battery formed from electrochemical cell stacks that include semi-solid electrodes relative to a similar battery formed form electrochemical cell stacks that include conventional electrodes. This substantially increases the overall charge capacity and energy density of a battery that includes the semi-solid electrodes described herein.

In some embodiments, the electrode materials described herein can be a flowable semi-solid or condensed liquid composition. In some embodiments, the electrode materials described herein can be binderless or substantially free of binder. A flowable semi-solid electrode can include a suspension of an electrochemically active material (anodic or cathodic particles or particulates), and optionally an electronically conductive material (e.g., carbon) in a non-aqueous liquid electrolyte. Said another way, the active electrode particles and conductive particles are co-suspended in an electrolyte to produce a semi-solid electrode. Examples of battery architectures utilizing semi-solid suspensions are described in International Patent Publication No. WO 2012/024499, entitled “Stationary, Fluid Redox Electrode,” and International Patent Publication No. WO 2012/088442, entitled “Semi-Solid Filled Battery and Method of Manufacture,” the entire disclosures of which are hereby incorporated by reference, respectively.

As used in this specification, the singular forms “a,” “an,” and “the” include plural referents unless the context clearly dictates otherwise. Thus, for example, the term “a member” is intended to mean a single member or a combination of members, “a material” is intended to mean one or more materials, or a combination thereof.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein, the term “semi-solid” refers to a material that is a mixture of liquid and solid phases, for example, such as a particle suspension, a slurry, a colloidal suspension, an emulsion, a gel, or a micelle.

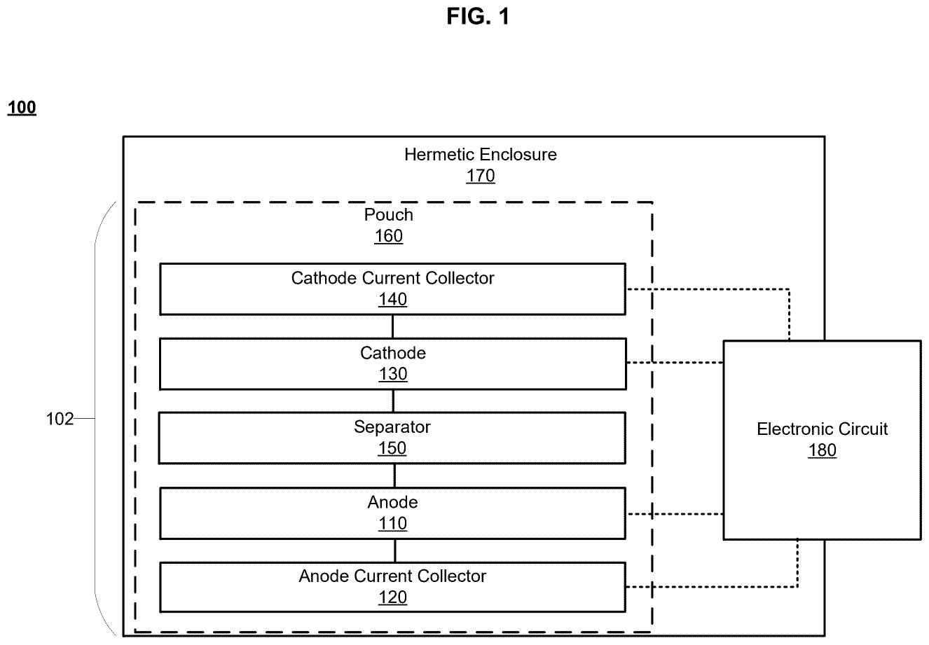

FIG. 1 is a block diagram of an electrochemical apparatus 100 including a hermetic seal, according to an embodiment. As shown, the electrochemical apparatus 100 includes an electrochemical cell 102 disposed in a hermetic enclosure 170. As shown, the electrochemical cell 102 includes an anode 110 disposed on an anode current collector 120, a cathode 130 disposed on a cathode current collector 140, and a separator 150 disposed between the anode 110 and the cathode 130. The anode 110, the anode current collector 120, the cathode 130, the cathode current collector 140, and the separator 150 are optionally disposed in a pouch 160, and the pouch 160 can be disposed in the hermetic enclosure 170. Electronic circuit 180 is in contact and/or communication with at least one of the anode 110, the anode current collector 120, the cathode 130, or the cathode current collector 140. The electronic circuit 180 is partially enclosed in the hermetic enclosure 170 and partially outside of the hermetic enclosure 170.

In some embodiments, the anode 110 can include a conventional or solid electrode. In some embodiments, the anode 110 can include a semi-solid electrode. In some embodiments, the cathode 130 can include a conventional or solid electrode. In some embodiments, the cathode 130 can include a semi-solid electrode. In some embodiments, the anode 110, the anode current collector 120, the cathode 130, the cathode current collector 140, and/or the separator 150 can include any of the properties of those described in the '903 patent.

The pouch 160 is optional and encloses the anode 110, the anode current collector 120, the cathode 130, the cathode current collector 140, and the separator 150. In some embodiments, the pouch can be composed of a plastic, a polymer, polyethylene, polypropylene, or any other suitable material or combinations thereof. In some embodiments, the pouch 160 can be without a hermetic seal. In some embodiments, the pouch 160 can include any of the properties of the pouches described in the '903 patent.

The hermetic enclosure 170 houses the electrochemical cell 102 and a portion of the electronic circuit 180. In some embodiments, the hermetic enclosure 170 can include an aluminized pouch. In other words, the hermetic enclosure 170 can include a layer of aluminum. In some embodiments, the hermetic enclosure 170 can include multiple layers. In some embodiments, the hermetic enclosure 170 can include a first layer including aluminum or any other metal and a second layer including a polymer.

In some embodiments, the hermetic enclosure 170 can have a high packing efficiency, such that the volume of the electrochemical apparatus 100 or a collection of electrochemical apparatuses not occupied by a component of the electrochemical apparatus (i.e., dead space) is minimized. In some embodiments, the packing efficiency of the electrochemical apparatus 100 can be at least about 80%, at least about 81%, at least about 82%, at least about 83%, at least about 84%, at least about 85%, at least about 86%, at least about 87%, at least about 88%, at least about 89%, at least about 90%, at least about 91%, at least about 92%, at least about 93%, at least about 94%, at least about 95%, at least about 96%, at least about 97%, at least about 98%, at least about 99%, at least about 99.1%, at least about 99.2%, at least about 99.3%, at least about 99.4%, at least about 99.5%, at least about 99.6%, at least about 99.7%, at least about 99.8%, or at least about 99.9%, inclusive of all values and ranges therebetween.

In some embodiments, the hermetic enclosure 170 can be constructed, formed, or assembled to reduce its inclusion of sharp corners. Sharp corners can cause embrittlement of the aluminized layer of the hermetic enclosure 170, potentially leading to the appearance of holes in the hermetic enclosure 170 or one or more layers thereof. By smoothing the corners of the electrochemical cell 102 during production (e.g., via chamfering or rounding the corners), sharp corners in the hermetic enclosure 170 can be reduced, preventing embrittlement. In some embodiments, soft materials (e.g., foam, rubber) can be included inside the hermetic enclosure 170 (i.e., between the corners of the electrochemical cell 102 and the hermetic enclosure 170) to smooth the corners of the hermetic enclosure 170 and prevent embrittlement.

As shown, the hermetic enclosure 170 includes a single electrochemical cell 102 disposed therein. In some embodiments, the hermetic enclosure 170 can include multiple electrochemical cells disposed therein. In some embodiments, the hermetic enclosure 170 can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, or at least about 900 electrochemical cells disposed therein. In some embodiments, the hermetic enclosure 170 can include no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 electrochemical cells disposed therein. In some embodiments, the hermetic enclosure 170 can include about 1, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, at least about 800, about 900, or about 1,000 electrochemical cells, inclusive disposed therein.

As shown, the electronic circuit 180 is disposed partially inside the hermetic enclosure 170 and partially outside the hermetic enclosure 170. In some embodiments, the electronic circuit 180 can include a circuit board, a printed circuit board, a flex circuit, a print flex circuit, any other suitable electronic circuit or any suitable combination thereof. In some embodiments, the electronic circuit 180 can be physically coupled to at least one of the anode 110, the anode current collector 120, the cathode 130, or the cathode current collector 140. In some embodiments, the electronic circuit 180 can be communicatively coupled to at least one of the anode 110, the anode current collector 120, the cathode 130, or the cathode current collector 140. In some embodiments, the separator 150 may include a multilayer separator, for example, a separator 150 that includes an interlayer (e.g., a conductive interlayer) disposed between two separator layers. In some embodiments, the separator 150 may include additional separator layers and interlayers. In such embodiments, the electronic circuit 180 may be communicatively coupled to at least one interlayer included in the separator 150. Examples of separators including interlayers that can be used as the separator 150 of electrochemical apparatus 100 or any other separator included in any outer electrochemical cell described herein, are described in PCT Publication No. WO 2024/130246, published Jun. 20, 2024, and entitled “Systems and Methods for Preventing Dendrite Formation in Electrochemical Cells,” the entire disclosure of which is hereby incorporated herein by reference in its entirety.

In some embodiments, the electronic circuit 180 can transmit electrical energy to and/or from the electrochemical cell 102. In some embodiments, the electronic circuit 180 can transmit electrical signals (e.g., instructions) to and/or from the electrochemical cell 102. In some embodiments, the transmission of electrical energy and/or electrical signals can be both into the electrochemical cell 102 and out of the electrochemical cell 102. In some embodiments, the instructions transmitted via the electronic circuit 180 can be in binary and/or machine language. In some embodiments, the electronic circuit 180 can include hardware that charges the electrochemical cell 102. In some embodiments, the electronic circuit 180 can include a printed flex circuit. In some embodiments, the electronic circuit 180 can be controlled via a battery management system (BMS). In some embodiments, the electronic circuit 180 can include an energy source (i.e., a secondary battery) integrated therein. In some embodiments, the electronic circuit 180 can be coupled to an energy source.

In some embodiments, at least about 1%, at least about 2%, at least about 3%, at least about 4%, at least about 5%, at least about 6%, at least about 7%, at least about 8%, at least about 9%, at least about 10%, at least about 20%, at least about 30%, at least about 40%, at least about 50%, at least about 60%, at least about 70%, at least about 80%, at least about 90%, at least about 91%, at least about 92%, at least about 93%, at least about 94%, at least about 95%, at least about 96%, at least about 97%, at least about 98%, or at least about 99% of the volume of the electronic circuit 180 can be contained inside the hermetic enclosure 170. In some embodiments, no more than about 99.5%, no more than about 99%, no more than about 98%, no more than about 97%, no more than about 96%, no more than about 95%, no more than about 94%, no more than about 93%, no more than about 92%, no more than about 91%, no more than about 90%, no more than about 90%, no more than about 80%, no more than about 70%, no more than about 60%, no more than about 50%, no more than about 40%, no more than about 30%, no more than about 20%, no more than about 10%, no more than about 9%, no more than about 8%, no more than about 7%, no more than about 6%, no more than about 5%, no more than about 4%, no more than about 3%, or no more than about 2% of the volume of the electronic circuit 180 can be contained inside the hermetic enclosure 170. Combinations of the above-referenced percentages are also possible (e.g., at least about 1% and no more than about 99.5% or at least about 30% and no more than about 70%), inclusive of all values and ranges therebetween. In some embodiments, about 1%, about 2%, about 3%, about 4%, about 5%, about 6%, about 7%, about 8%, about 9%, about 10%, about 20%, about 30%, about 40%, about 50%, about 60%, about 70%, about 80%, about 90%, about 91%, about 92%, about 93%, about 94%, about 95%, about 96%, about 97%, about 98%, about 99%, or about 99.5% of the volume of the electronic circuit 180 can be contained inside the hermetic enclosure 170.

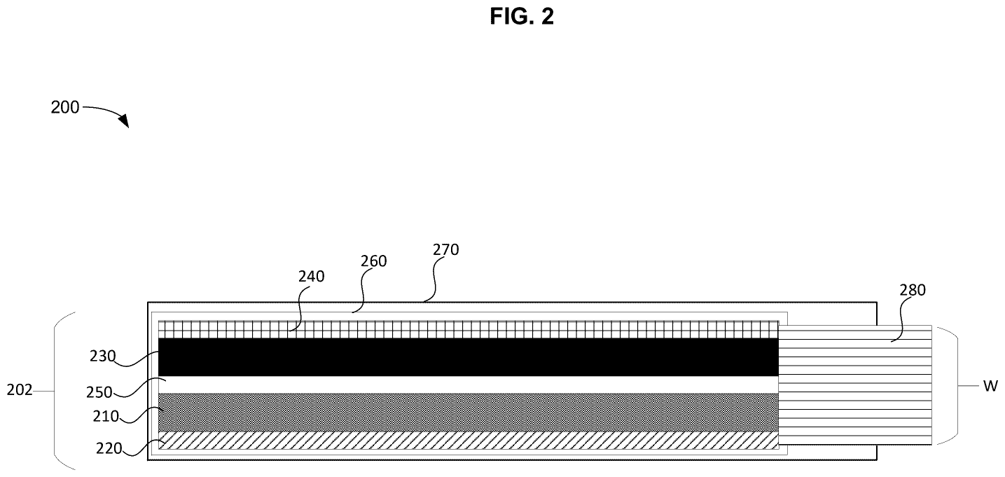

FIG. 2 is an illustration of an electrochemical apparatus 200 including a hermetic seal, according to an embodiment. As shown, the electrochemical apparatus 200 includes an electrochemical cell 202 in a hermetic enclosure 270 and an electronic circuit 280 coupled to the electrochemical cell 202. In some embodiments, the electronic circuit 280 may include a circuit board and/or a printed flex circuit. As shown, the electrochemical cell 202 includes an anode 210 disposed on an anode current collector 220, a cathode 230 disposed on a cathode current collector 240, a separator 250 disposed between the anode 210 and the cathode 230, and a pouch 260 encasing the anode 210, the anode current collector 220, the cathode 230, the cathode current collector 240, and the separator 250. In some embodiments, the anode 210, the anode current collector 220, the cathode 230, the cathode current collector 240, the separator 250, the pouch 260, the hermetic enclosure 270, and the electronic circuit 280 can be the same or substantially similar to the anode 110, the anode current collector 120, the cathode 130, the cathode current collector 140, the separator 150, the pouch 160, the hermetic enclosure 170, and the electronic circuit 180, as described above with reference to FIG. 1. Thus, certain aspects of the anode 210, the anode current collector 220, the cathode 230, the cathode current collector 240, the separator 250, the pouch 260, the hermetic enclosure 270, and the electronic circuit 280 are not described in greater detail herein. As shown, the electrochemical cell 202 is inside the pouch 260. In some embodiments, the electrochemical cell 202 can be disposed inside of a can (e.g., a cylindrical can). In some embodiments, the electrochemical cell 202 can include a prismatic cell.

As shown, the hermetic enclosure 270 encloses the electrochemical cell 202. The electronic circuit 280 can be inserted into the hermetic enclosure 270 to minimize the humidity penetration rate of the hermetic enclosure 270. In some embodiments, the hermetic enclosure 270 can have a humidity penetration rate of no more than about 1×10⁻⁷ cc/s, no more than about 9×10⁻⁸ cc/s, no more than about 8×10⁻⁸ cc/s, no more than about 7×10⁻⁸ cc/s, no more than about 6×10⁻⁸ cc/s, no more than about 5×10⁻⁸ cc/s, no more than about 4×10⁻⁸ cc/s, no more than about 3×10⁻⁸ cc/s, no more than about 2×10⁻⁸ cc/s, no more than about 1×10⁻⁸ cc/s, no more than about 9×10⁻⁹ cc/s, no more than about 8×10⁻⁹ cc/s, no more than about 7×10⁻⁹ cc/s, no more than about 6×10⁻⁹ cc/s, no more than about 5×10⁻⁹ cc/s, no more than about 4×10⁻⁹ cc/s, no more than about 3×10⁻⁹ cc/s, no more than about 2×10⁻⁹ cc/s, or no more than about 1×10⁻⁹ cc/s, inclusive.

As shown, the electronic circuit 280 penetrates the hermetic enclosure 270 and contacts the electrochemical cell 202. In some embodiments, the electronic circuit can penetrate the pouch 260 as well. In some embodiments, the electronic circuit 280 can include a printed flex circuit. In some embodiments, the electronic circuit 280 can be sufficiently thin, such that the electronic circuit does not compromise the hermeticity of the hermetic enclosure 270. In some embodiments, the electronic circuit 280 can have a thickness of at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.1 mm, at least about 1.2 mm, at least about 1.3 mm, at least about 1.4 mm, at least about 1.5 mm, at least about 1.6 mm, at least about 1.7 mm, at least about 1.8 mm, or at least about 1.9 mm, inclusive. In some embodiments, the electronic circuit 280 can have a thickness of no more than about 2 mm, no more than about 1.9 mm, no more than about 1.8 mm, no more than about 1.7 mm, no more than about 1.6 mm, no more than about 1.5 mm, no more than about 1.4 mm, no more than about 1.3 mm, no more than about 1.2 mm, no more than about 1.1 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm, inclusive. Combinations of the above-referenced thicknesses are also possible (e.g., at least about 10 μm and no more than about 2 mm or at least about 100 μm and no more than about 1 mm), inclusive of all values and ranges therebetween. In some embodiments, the electronic circuit 280 can have a thickness of about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, or about 2 mm, inclusive.

In some embodiments, the electronic circuit 280 can have a width W of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 2 cm, at least about 3 cm, at least about 4 cm, at least about 5 cm, at least about 6 cm, at least about 7 cm, at least about 8 cm, at least about 9 cm, at least about 10 cm, at least about 20 cm, at least about 30 cm, at least about 40 cm, at least about 50 cm, at least about 60 cm, at least about 70 cm, at least about 80 cm, or at least about 90 cm, inclusive. In some embodiments, the electronic circuit 280 can have a width W of no more than about 1 m, no more than about 90 cm, no more than about 80 cm, no more than about 70 cm, no more than about 60 cm, no more than about 50 cm, no more than about 40 cm, no more than about 30 cm, no more than about 20 cm, no more than about 10 cm, no more than about 9 cm, no more than about 8 cm, no more than about 7 cm, no more than about 6 cm, no more than about 5 cm, no more than about 4 cm, no more than about 3 cm, no more than about 2 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm, inclusive. Combinations of the above-referenced widths W are also possible (e.g., at least about 1 mm and no more than about 1 m or at least about 1 cm and no more than about 10 cm), inclusive of all values and ranges therebetween. In some embodiments, the electronic circuit 280 can have a width W of about 1 mm, about 2 mm, about 3 mm, about 4 mm, about 5 mm, about 6 mm, about 7 mm, about 8 mm, about 9 mm, about 1 cm, about 2 cm, about 3 cm, about 4 cm, about 5 cm, about 6 cm, about 7 cm, about 8 cm, about 9 cm, about 10 cm, about 20 cm, about 30 cm, about 40 cm, about 50 cm, about 60 cm, about 70 cm, about 80 cm, about 90 cm, or about 1 m, inclusive.

In some embodiments, the width W of the electronic circuit 280 can be uniform along the length of the electronic circuit 280. In some embodiments, the width W of the electronic circuit 280 can be non-uniform along the length of the electronic circuit 280. In other words, the electronic circuit 280 can broaden or narrow along its length. In some embodiments, the electronic circuit 280 can be oriented with its width W extending along the height of the electrochemical cell 202 (as shown in FIG. 2). In some embodiments, the electronic circuit 280 can be oriented with its width W extending along the width of the electrochemical cell 202.

In some embodiments, the width W of the electronic circuit 280 can be at least about 5%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, or at least about 95%, inclusive of the width of the electrochemical cell 202. In some embodiments, the width W of the electronic circuit 280 can be no more than about 100%, no more than about 95%, no more than about 90%, no more than about 85%, no more than about 80%, no more than about 75%, no more than about 70%, no more than about 65%, no more than about 60%, no more than about 55%, no more than about 50%, no more than about 45%, no more than about 40%, no more than about 35%, no more than about 30%, no more than about 25%, no more than about 20%, no more than about 15%, or no more than about 10%, inclusive of the width of the electrochemical cell 202. Combinations of the above-referenced width percentages are also possible (e.g., at least about 5% and no more than about 95% or at least about 20% and no more than about 80%), inclusive of all values and ranges therebetween. In some embodiments, the width W of the electronic circuit 280 can be about 5%, about 10%, about 15%, about 20%, about 25%, about 30%, about 35%, about 40%, about 45%, about 50%, about 55%, about 60%, about 65%, about 70%, about 75%, about 80%, about 85%, about 90%, about 95%, or about 100%, inclusive of the width of the electrochemical cell 202.

In some embodiments, the electronic circuit 280 can have a width-to-thickness aspect ratio of at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, or at least about 900, inclusive. In some embodiments, the electronic circuit 280 can have a width-to-thickness aspect ratio of no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2, inclusive. Combinations of the above-referenced width-to-thickness ratios are also possible (e.g., at least about 1 and no more than about 1,000 or at least about 10 and no more than about 100), inclusive of all values and ranges therebetween. In some embodiments, the electronic circuit 280 can have a width-to-thickness aspect ratio of about 1, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, or about 1,000, inclusive.

In some embodiments, the electronic circuit 280 can include a collection of wires that penetrate the hermetic enclosure 270. In some embodiments, the electronic circuit 280 can include at least about 1, at least about 2, at least about 3, at least about 4, at least about 5, at least about 6, at least about 7, at least about 8, at least about 9, at least about 10, at least about 20, at least about 30, at least about 40, at least about 50, at least about 60, at least about 70, at least about 80, at least about 90, at least about 100, at least about 200, at least about 300, at least about 400, at least about 500, at least about 600, at least about 700, at least about 800, or at least about 900 wires, inclusive that penetrate the hermetic enclosure 270. In some embodiments, the electronic circuit 280 can include no more than about 1,000, no more than about 900, no more than about 800, no more than about 700, no more than about 600, no more than about 500, no more than about 400, no more than about 300, no more than about 200, no more than about 100, no more than about 90, no more than about 80, no more than about 70, no more than about 60, no more than about 50, no more than about 40, no more than about 30, no more than about 20, no more than about 10, no more than about 9, no more than about 8, no more than about 7, no more than about 6, no more than about 5, no more than about 4, no more than about 3, or no more than about 2 wires, inclusive that penetrate the hermetic enclosure 270. Combinations of the above-referenced numbers of wires are also possible (e.g., at least about 1 and no more than about 1,000 or at least about 50 and no more than about 500), inclusive of all values and ranges therebetween. In some embodiments, the electronic circuit 280 can include about 1, about 2, about 3, about 4, about 5, about 6, about 7, about 8, about 9, about 10, about 20, about 30, about 40, about 50, about 60, about 70, about 80, about 90, about 100, about 200, about 300, about 400, about 500, about 600, about 700, about 800, about 900, or about 1,000 wires, inclusive that penetrate the hermetic enclosure 270.

In some embodiments, the electronic circuit 280 can include copper. In some embodiments, the electronic circuit 280 can include aluminum. In some embodiments, the electronic circuit 280 can include nickel. In some embodiments, the electronic circuit 280 can include other metallic alloys. In some embodiments, the electronic circuit 280 can include conductive polymer, copolymers, or other conductive materials. In some embodiments, the electronic circuit 280 can include polyimide, polypropylene, polyethylene, any other suitable polymer, copolymer, or any combination thereof. In some embodiments, the electronic circuit 280 can be coated with polyimide. In some embodiments, the electronic circuit can include a flexible section and a non-flexible section, such that the flexible section straddles the line between the inside and the outside of the hermetic enclosure 270. In some embodiments, the electronic circuit 280 can include fiberglass. In some embodiments, the electronic circuit 180 can include an epoxy resin.

In some embodiments, the electronic circuit 280 (or the flexible portion thereof) can have a flexural modulus of at least about 20 GPa, at least about 30 Gpa, at least about 40 Gpa, at least about 50 Gpa, at least about 60 Gpa, at least about 70 Gpa, at least about 80 Gpa, at least about 90 Gpa, at least about 100 Gpa, at least about 110 Gpa, at least about 120 Gpa, at least about 130 Gpa, or at least about 140 Gpa, inclusive. In some embodiments, the electronic circuit 280 can have a flexural modulus of no more than about 150 Gpa, no more than about 140 Gpa, no more than about 130 Gpa, no more than about 120 Gpa, no more than about 110 Gpa, no more than about 100 Gpa, no more than about 90 Gpa, no more than about 80 Gpa, no more than about 70 Gpa, no more than about 60 Gpa, no more than about 50 Gpa, no more than about 40 Gpa, or no more than about 30 Gpa, inclusive. Combinations of the above-referenced flexural moduli are also possible (e.g., at least about 20 Gpa and no more than about 150 Gpa or at least about 40 Gpa and no more than about 80 Gpa), inclusive of all values and ranges therebetween. In some embodiments, the electronic circuit 280 can have a flexural modulus of about 20 Gpa, about 30 Gpa, about 40 Gpa, about 50 Gpa, about 60 Gpa, about 70 Gpa, about 80 Gpa, about 90 Gpa, about 100 Gpa, about 110 Gpa, about 120 Gpa, about 130 Gpa, about 140 Gpa, or about 150 Gpa, inclusive.

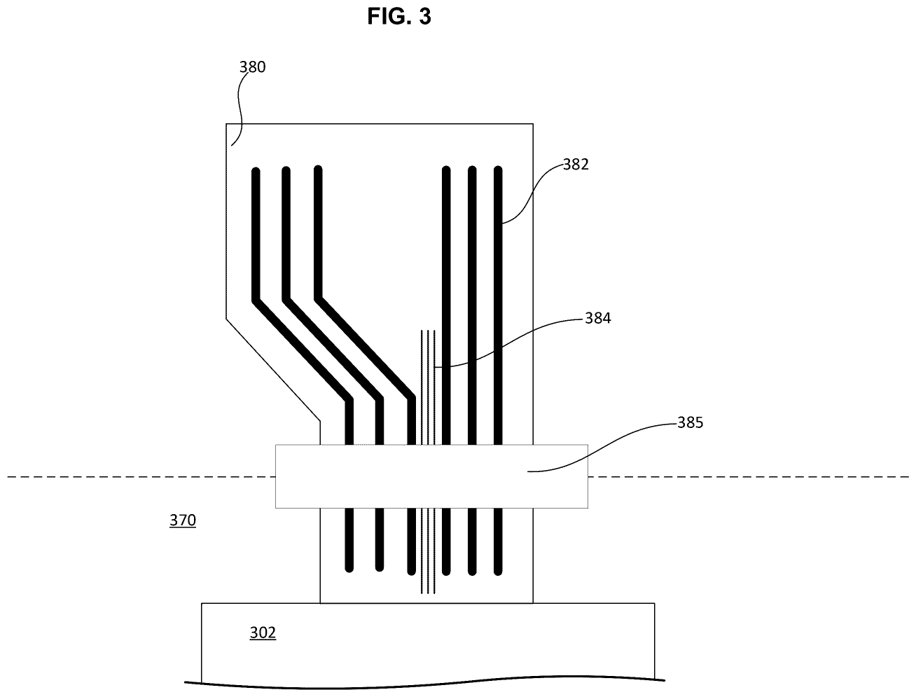

FIG. 3 is an illustration of an interface between an electronic circuit 380 (e.g., a circuit board and/or a printed flex circuit) and an electrochemical cell 302, according to an embodiment. As shown, the electronic circuit 380 is partially enclosed in a hermetic enclosure 370 with a sealing member 385 at the interface between the electronic circuit 380 and the hermetic enclosure 370. As shown, the electronic circuit 380 includes primary traces 382 and secondary traces 384. In some embodiments, the electrochemical cell 302, the hermetic enclosure 370, and the electronic circuit 380 can be the same or substantially similar to the electrochemical cell 102, the hermetic enclosure 170, and the electronic circuit 180, as described above with reference to FIG. 1. Thus, certain aspects of the electrochemical cell 302, the hermetic enclosure 370, and the electronic circuit 380 are not described in greater detail herein.

As shown, the primary traces 382 are broader than the secondary traces 384. In some embodiments, the primary traces 382 have greater current carrying capacity through the electronic circuit 380, as compared to the secondary traces 384.

The sealing member 385 provides additional sealing support at the interface between the inside and the outside of the hermetic enclosure 370. In some embodiments, the sealing member 385 can include a sealing tape. In some embodiments, the sealing member 385 can be composed of polypropylene, polyethylene, or any other suitable sealing material. In some embodiments, the sealing member 385 can include an adhesive coated on the inside (i.e., the side facing the electronic circuit 380) and/or the outside (i.e., the side facing the hermetic enclosure 370).

In some embodiments, the sealing member 385 can have a thickness of at least about 10 μm, at least about 20 μm, at least about 30 μm, at least about 40 μm, at least about 50 μm, at least about 60 μm, at least about 70 μm, at least about 80 μm, at least about 90 μm, at least about 100 μm, at least about 200 μm, at least about 300 μm, at least about 400 μm, at least about 500 μm, at least about 600 μm, at least about 700 μm, at least about 800 μm, at least about 900 μm, at least about 1 mm, at least about 1.1 mm, at least about 1.2 mm, at least about 1.3 mm, at least about 1.4 mm, at least about 1.5 mm, at least about 1.6 mm, at least about 1.7 mm, at least about 1.8 mm, or at least about 1.9 mm, inclusive. In some embodiments, the sealing member 385 can have a thickness of no more than about 2 mm, no more than about 1.9 mm, no more than about 1.8 mm, no more than about 1.7 mm, no more than about 1.6 mm, no more than about 1.5 mm, no more than about 1.4 mm, no more than about 1.3 mm, no more than about 1.2 mm, no more than about 1.1 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm, inclusive. Combinations of the above-referenced thicknesses are also possible (e.g., at least about 10 μm and no more than about 2 mm or at least about 100 μm and no more than about 1 mm), inclusive of all values and ranges therebetween. In some embodiments, the sealing member 385 can have a thickness of about 10 μm, about 20 μm, about 30 μm, about 40 μm, about 50 μm, about 60 μm, about 70 μm, about 80 μm, about 90 μm, about 100 μm, about 200 μm, about 300 μm, about 400 μm, about 500 μm, about 600 μm, about 700 μm, about 800 μm, about 900 μm, about 1 mm, about 1.1 mm, about 1.2 mm, about 1.3 mm, about 1.4 mm, about 1.5 mm, about 1.6 mm, about 1.7 mm, about 1.8 mm, about 1.9 mm, or about 2 mm, inclusive.

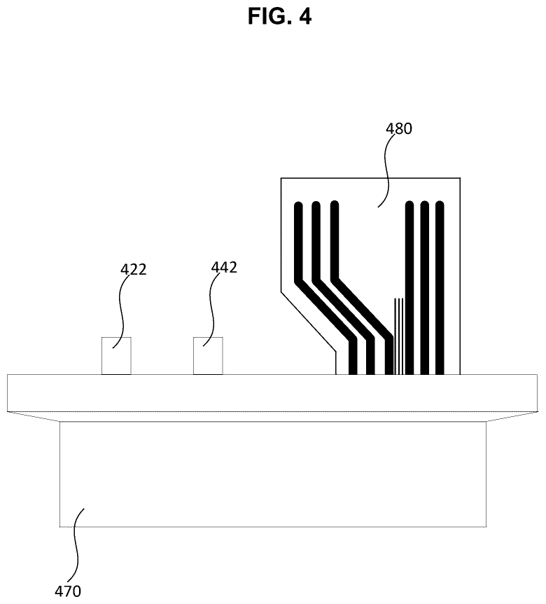

FIG. 4 is an illustration of an interface between an electronic circuit 480 (e.g., a circuit board or printed flex circuit) and a hermetic enclosure 470, according to an embodiment. In some embodiments, the hermetic enclosure 470 and the electronic circuit 480 can be the same or substantially similar to the hermetic enclosure 170 and the electronic circuit 180, as described above with reference to FIG. 1. Thus, certain aspects of the electronic circuit 480 and the hermetic enclosure 470 are not described in greater detail herein.

As shown, an anode tab 422 and a cathode tab 442 protrude through the hermetic enclosure 470. The anode tab 422 is coupled to an anode current collector (not shown) inside the hermetic enclosure 470 and the cathode tab 442 is coupled to a cathode current collector (not shown) inside the hermetic enclosure 470. In some embodiments, the anode tab 422 can include a sealing member (not shown) disposed at an interface between the anode tab 422 and the hermetic enclosure 470. In some embodiments, the cathode tab 442 can include a sealing member (not shown) disposed at an interface between the cathode tab 442 and the hermetic enclosure 470. Either of these sealing members can have any of the properties of the sealing member 385, as described above with reference to FIG. 3. As shown, the anode tab 422, the cathode tab 442, and the electronic circuit 480 protrude from the hermetic enclosure 470 at three different locations. In some embodiments, the anode tab 422, the cathode tab 442, and the electronic circuit 480 can protrude from the hermetic enclosure 470 at a single location or at two locations (or more locations) to limit the number of openings in the hermetic enclosure 470.

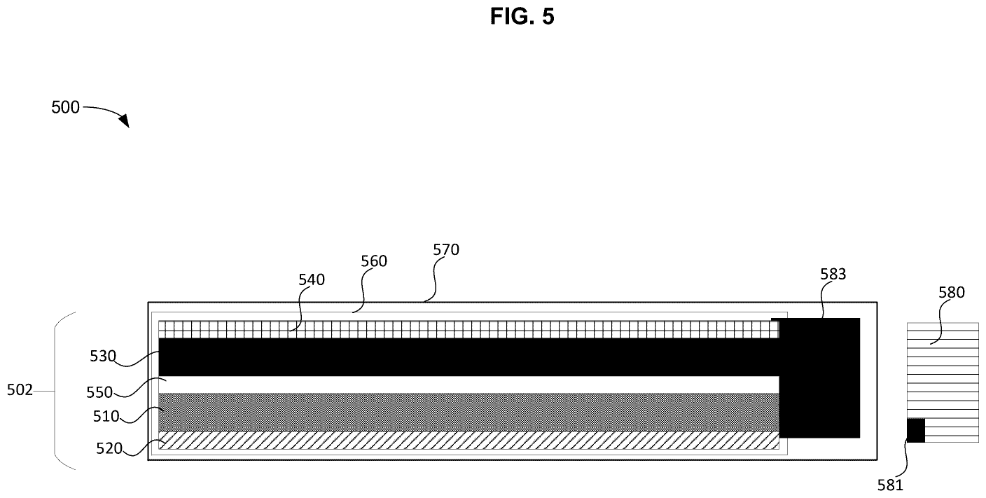

FIG. 5 is an illustration of an electrochemical apparatus 500 including a hermetic seal, according to an embodiment. The electrochemical apparatus 500 includes an electronic circuit 580 that can transmit electrical energy and/or electrical signals remotely. As shown, the electrochemical apparatus 500 includes an electrochemical cell 502 and the electronic circuit 580. The electrochemical cell 502 includes an anode 510, an anode current collector 520, a cathode 530, a cathode current collector 540, a separator 550, and a pouch 560. The electrochemical cell 502 is contained inside a hermetic enclosure 570 (e.g., disposed within an internal volume thereof). In some embodiments, the anode 510, the anode current collector 520, the cathode 530, the cathode current collector 540, the separator 550, the pouch 560, and the hermetic enclosure 570 can be the same or substantially similar to the anode 110, the anode current collector 120, the cathode 130, the cathode current collector 140, the separator 150, the pouch 160, and the hermetic enclosure 170, as described above with reference to FIG. 1. Thus, certain aspects of the anode 510, the anode current collector 520, the cathode 530, the cathode current collector 540, the separator 550, the pouch 560, and the hermetic enclosure 570 are not described in greater detail herein.

As shown, the electrochemical cell 502 is positioned inside of the hermetic enclosure 570 and the electronic circuit 580 is positioned outside of the hermetic enclosure 570. The electronic circuit 580 includes a transmitter 581. A receiver 583 is positioned inside the hermetic enclosure 570 and is in contact with the electrochemical cell 502. In some embodiments, the receiver 583 can contact the anode 510, the anode current collector 520, the cathode 530, and/or the cathode current collector 540. In use, the transmitter 581 transmits electrical energy and/or electrical signals to the receiver 583. In some embodiments, the transmitter 581 can also receive electrical energy and/or electrical signals from the receiver 583. The electrochemical cell 502 and the electronic circuit 580 are not physically connected as they are on opposite sides of the hermetic enclosure 570. In some embodiments, modeled signals (e.g., electrical signals, charging/discharging signals, calibration signals, etc.) can pass through the hermetic enclosure 570 via the transmitter 581 and the receiver 583.

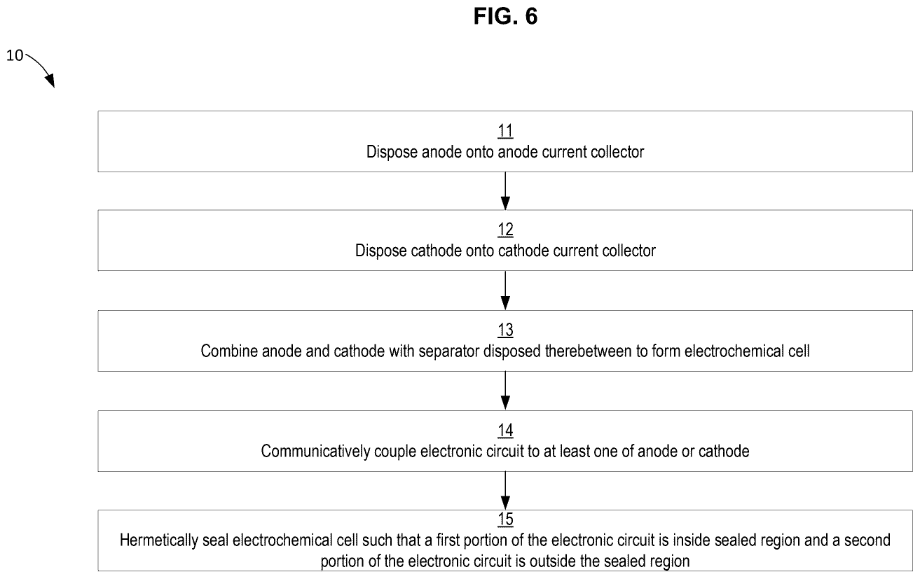

FIG. 6 is a flow diagram of a method 10 of forming an electrochemical apparatus including a hermetic seal, according to an embodiment. As shown, the method 10 includes disposing an anode onto an anode current collector at step 11, disposing a cathode onto a cathode current collector at step 12, combining the anode and the cathode with a separator disposed therebetween to form an electrochemical cell at step 13, communicatively coupling an electronic circuit to at least one of the anode or the cathode at step 14, and hermetically sealing the electrochemical cell at step 15, such that a first portion of the electronic circuit is inside a sealed region and a second portion of the electronic circuit is outside of the sealed region.

Step 11 includes disposing an anode onto an anode current collector. In some embodiments, the anode and/or the anode current collector can have any of the properties of anodes and/or anode current collectors described in the '903 patent. In some embodiments, the anode can include a semi-solid anode. In some embodiments, anode material can be disposed onto the anode current collector via an assembly line. In some embodiments, the anode can include a conventional solid anode.

Step 12 includes disposing a cathode onto a cathode current collector. In some embodiments, the cathode and/or the cathode current collector can have any of the properties of the cathodes and/or cathode current collectors described in the '903 patent. In some embodiments, the cathode can include a semi-solid cathode. In some embodiments, cathode material can be disposed onto the cathode current collector via an assembly line. In some embodiments, the cathode can include a conventional solid cathode.

Step 13 includes combining the anode and the cathode with a separator disposed therebetween to form an electrochemical cell. In some embodiments, the combination of the electrodes can be via rollers and/or an assembly line. For example, the anode and anode current collector can be conveyed via a first set of rollers, the cathode and cathode current collector can be conveyed via a second set of rollers, and the separator can move via a third set of rollers that guide the movement of the separator to be between the anode/anode current collector and the cathode/cathode current collector.

Step 14 includes communicatively coupling an electronic circuit to at least one of the anode or the cathode. In some embodiments, the coupling can include physically coupling the electronic circuit to the anode, the anode current collector, the cathode, and/or the cathode current collector. In some embodiments, the coupling can include physically coupling a receiver to the anode, the anode current collector, the cathode, and/or the cathode current collector and communicatively engaging the electronic circuit to the receiver. In such a case, the electronic circuit can be physically not coupled to either of the electrodes or current collectors (e.g., wireless coupled thereto via the receiver). In some embodiments, step 14 can include coupling (e.g., physically coupling) a printed flex circuit to the anode, the anode current collector, the cathode, and/or the cathode current collector.

Step 15 includes hermetically sealing the electrochemical cell in a hermetic enclosure, such that a first portion of the electronic circuit is inside a sealed region and a second portion of the electronic circuit is outside of the sealed region. In some embodiments, the first portion of the electronic circuit and the second portion of the electronic circuit can be part of a single piece of material. In some embodiments, the first portion of the electronic circuit can be physically disjointed from the second portion of the electronic circuit (i.e., in cases where signals and/or energy are transmitted remotely via a transmitter and a receiver). In some embodiments, the sealing can occur directly on the electronic circuit. In some embodiments, the sealing can occur around a sealing member (e.g., a tape) disposed around the electronic circuit. In some embodiments, the sealing can include the use of an adhesive. In some embodiments, the sealing can be around a very narrow opening in the hermetic enclosure. In some embodiments, the opening in the hermetic enclosure can have a thickness of no more than about 2 mm, no more than about 1.9 mm, no more than about 1.8 mm, no more than about 1.7 mm, no more than about 1.6 mm, no more than about 1.5 mm, no more than about 1.4 mm, no more than about 1.3 mm, no more than about 1.2 mm, no more than about 1.1 mm, no more than about 1 mm, no more than about 900 μm, no more than about 800 μm, no more than about 700 μm, no more than about 600 μm, no more than about 500 μm, no more than about 400 μm, no more than about 300 μm, no more than about 200 μm, no more than about 100 μm, no more than about 90 μm, no more than about 80 μm, no more than about 70 μm, no more than about 60 μm, no more than about 50 μm, no more than about 40 μm, no more than about 30 μm, or no more than about 20 μm, inclusive of all values and ranges therebetween.

In some embodiments, the sealing can include the use of an adhesive. In some embodiments, the adhesive can be on or at an interface between the hermetic enclosure and the electronic circuit. In some embodiments, the adhesive can be on an interface between the sealing member and the electronic circuit. In some embodiments, the adhesive can be on an interface between the sealing member and the hermetic enclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,”“holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An electrochemical cell assembly, comprising:
an anode current collector;
an anode disposed on the anode current collector;
a cathode current collector;
a cathode disposed on the cathode current collector;
a separator disposed between the anode and the cathode;
a hermetic enclosure configured to house the anode, the anode current collector, the cathode, the cathode current collector, and the separator; and
an electronic circuit electrically and/or communicatively coupled to at least one of the anode or the cathode, such that a first portion of the electronic circuit is inside the hermetic enclosure and a second portion of the electronic circuit is outside the hermetic enclosure.

2. The electrochemical cell assembly of claim 1, wherein the electronic circuit includes a printed flex circuit.

3. The electrochemical cell assembly of claim of claim 2, wherein the printed flex circuit includes polyimide.

4. The electrochemical cell assembly of claim 1, wherein the hermetic enclosure includes an aluminized polymer pouch.

5. The electrochemical cell assembly of claim 1, further comprising:
a sealing tape disposed at an interface between the electronic circuit and the hermetic enclosure to provide hermeticity.

6. The electrochemical cell assembly of claim 1, wherein the hermetic enclosure has a humidity penetration rate of no more than about 1×10⁻⁸ cc/s.

7. The electrochemical cell assembly of claim 1, further comprising:
a soft material disposed inside the hermetic enclosure, the soft material configured to smooth corners to the hermetic enclosure to inhibit embrittlement.

8. The electrochemical cell assembly of claim 1, further comprising:
a pouch disposed within the hermetic enclosure, the anode, the anode current collector, the cathode, the cathode current collector, and the separator enclosed within the pouch.

9. The electrochemical cell assembly of claim 8, wherein a portion of the electronic circuit penetrates inside the pouch.

10. An electrochemical device, comprising:
an electrochemical cell;
a hermetic enclosure configured to house the electrochemical cell; and
a printed flex circuit communicatively coupled to the electrochemical cell, the printed flex circuit positioned such that a first portion of the printed flex circuit is inside the hermetic enclosure and a second portion of the printed flex circuit is outside the hermetic enclosure.

11. The electrochemical device of claim 10, further comprising:
a sealing tape disposed at an interface between the printed flex circuit and the hermetic enclosure to provide hermeticity.

12. The electrochemical device of claim 10, wherein the printed flex circuit includes polyimide.

13. The electrochemical device of claim 10, wherein the hermetic enclosure has a humidity penetration rate of no more than about 1×10⁻⁸ cc/s.

14. The electrochemical device of claim 10, wherein:
the electrochemical cell includes a pouch housing components of the electrochemical cell, and
a portion of the printed flex circuit penetrates inside the pouch.

15. The electrochemical device of claim 10, wherein hermetic enclosure includes a first layer including an electrically conductive material and a second layer including an electrically insulative material.

16. The electrochemical device of claim 10, wherein the printed flex circuit has a width to thickness ratio of at least about 1.

17. A method, comprising:
disposing an anode on an anode current collector;
disposing a cathode on a cathode current collector;
disposing a separator between the anode and the cathode to form an electrochemical cell;
communicatively coupling an electronic circuit to at least one of the anode or the cathode; and
hermetically sealing the electrochemical cell inside a sealed region such that a first portion of the electronic circuit is inside the sealed region and a second portion of the electronic circuit is outside the sealed region.

18. The method of claim 17, wherein the communicative coupling the electronic circuit includes physically coupling the electronic circuit to the at least one of the anode or the cathode.

19. The method of claim 17, wherein the communicative coupling the electronic circuit includes physically coupling a receiver to the anode or the cathode and communicatively coupling the electronic circuit to the receiver such that the electronic circuit is not physically coupled to the at least one of the anode or the cathode.

20. The method of claim 17, wherein the first portion and the second portion of the electronic circuit are part of a single piece of material.

21. The method of claim 17, wherein the first portion of the electronic circuit is physically disjointed from the second portion of the electronic circuit.

22. The method of claim 21, further comprising:
disposing an adhesive at an interface between the sealed region and the electronic circuit.

23. The method of claim 17, wherein the hermetically sealing includes:
disposing a sealing member around the electronic circuit, and
disposing a portion of the sealed region around the sealing member.

24. The method of claim 23, wherein the hermetically sealing further includes:
disposing an adhesive on an interface between the sealing member and electronic circuit.
